(19) United States
(12) Patent Application Publication
(10) Pub. No.: US 2003/0002101 A1
(43) Pub. Date: Jan. 2, 2003

(54) Device and method for multiplexing and/or demultiplexing optical signals of a plurality of wavelengths

(76) Inventors: Jorg-Reinhardt Kropp, Berlin (DE); Robert Elschner, Berlin (DE); Hans Joachim Eichler, Berlin (DE); Ron Schulz, Berlin (DE)

Correspondence Address: LERNER AND GREENBERG, P.A., Post Office Box 2480, Hollywood, FL, 33022-2480, US

(21) Appl. No.: 10/079,731

(22) Filed: Feb. 21, 2002

(30) Foreign Application Priority Data
Jul. 2, 2001 (WO) PCT/DE01/02446

(51) Int. Cl. G02B 6/28; H04J 14/02

(52) U.S. Cl. 359/124; 385/24

(57) ABSTRACT

A device and a method for multiplexing and/or demultiplexing optical signals of a plurality of wavelengths. The optical signals of the various wavelengths are combined or separated in a wavelength-selective manner. To combine or separate the individual wavelengths, only one wavelength-selective filter is used, and the optical signals are routed in such a way that they repeatedly strike the wavelength-selective filter at respectively different angles. The optical signals of only one specific wavelength are coupled in or out for each angle.

### BACKGROUND OF THE INVENTION

1. Field of the Invention

The invention relates to a device and a method for multiplexing and/or demultiplexing optical signals of a plurality of wavelengths.

In optical telecommunications technology, in order to transmit the greatest possible quantity of data via an optical waveguide, it is known to multiplex the data to be transmitted. One possibility is to transmit information via an optical waveguide independently and simultaneously with a plurality of wavelengths. In this case, it is necessary to combine the signals from the various light sources into one optical waveguide using an optical multiplexer on the transmitting side. On the receiver side, it is also necessary to use an optical demultiplexer to divide the signals of the various wavelengths from the incoming optical waveguide into individual channels for separate detection.

In order to implement multiplexing or demultiplexing, Published European Patent Application EP-A-0 877 264 discloses the practice of separating the individual wavelengths using interference filters. By using a large number of interference layers, the interference filters produce very steep spectral edges between the transmission and reflection of different wavelengths. In this case, only a specific wavelength is let through by the interference filters, while the other wavelengths are reflected. By cascading such filters with individually different spectral transmission layers, selection or combination of a multiplicity of wavelength channels can be carried out. Using interference filters is extremely effective, in particular when there are relatively large wavelength intervals of 10 nm or more between the individual channels. Cascading a plurality of different filters can be carried out in a parallel optical beam path. A precondition for this is to use lenses or mirrors to form the beam. For the case in which the light is routed in optical waveguides, arrangements are known in which the light from one optical waveguide is reflected at an angle at a reflecting surface, and after the reflection, is routed onward in a further optical waveguide, the mirror being designed to be wavelength-selective. In this case, cascading is carried out by routing the optical waveguides in a zig-zag between a plurality of wavelength-selective mirrors. The drawback is that when filters are used in a cascade of filters, they must be very precisely designed and matched to one another. This is complicated and entails high costs.

### SUMMARY OF THE INVENTION

It is accordingly an object of the invention to provide a device and a method for multiplexing and/or demultiplexing optical signals which overcome the above-mentioned disadvantages of the prior art apparatus and methods of this general type.

In particular, it is an object of the invention to provide a device and a method for multiplexing and/or demultiplexing optical signals, which can be produced and employed cost-effectively, and in addition, which can simplify the use of wavelength-selective filters.

With the foregoing and other objects in view there is provided, in accordance with the invention, an optical device, including: only one wavelength-selective filter for either combining a plurality of wavelengths having optical signals in a wavelength-selective manner or separating a plurality of wavelengths having optical signals in a wavelength-selective manner. The optical signals are routed to repeatedly strike the wavelength-selective filter at respectively different angles such that at each one of the angles, only the optical signals of a specific one of the plurality of the wavelengths are either coupled in or coupled out.

In accordance with an added feature of the invention, there is provided, at least one reflecting surface. Lght including the plurality of the wavelengths is reflected to and fro between the wavelength-selective filter and the at least one reflecting surface such that after each reflection from the at least one reflecting surface, the light strikes the wavelength-selective filter at a different one of the angles.

In accordance with an additional feature of the invention, there is provided, a plurality of reflecting surfaces that are configured at an angle with respect to the wavelength-selective filter. The plurality of the reflecting surfaces include the at least one reflecting surface.

In accordance with another feature of the invention, each one of the plurality of the reflecting surfaces are inclined at a different angle with respect to the wavelength-selective filter.

In accordance with a further feature of the invention, each one of the plurality of the reflecting surfaces are at a different distance away from the wavelength-selective filter.

In accordance with a further added feature of the invention, there is provided, an optical waveguide that emits light including the plurality of the wavelengths; and an optical imaging system that forms the emitted light into a substantially parallel bundle of light including the plurality of the wavelengths. Each one of the plurality of the wavelengths of the substantially parallel bundle, streams through the wavelength-selective filter at an angle that is different from other ones of the plurality of the wavelengths of the substantially parallel bundle.

In accordance with a further additional feature of the invention, there is provided, a plurality of detectors; and a plurality of further optical imaging systems for imaging each one of the plurality of the wavelengths of the substantially parallel bundle onto a respective one of the plurality of the detectors.

In accordance with yet an added feature of the invention, there is provided, a multichannel interface element. The plurality of the further optical imaging systems are integrated into the multichannel interface element.

In accordance with yet an additional feature of the invention, there is provided, a multiplexing element having a surface on which the wavelength-selective filter is configured. The multiplexing element has at least one further surface forming a plurality of reflecting surfaces that are configured obliquely.

In accordance with yet another feature of the invention, there is provided, an optical waveguide that is repeatedly led up to the wavelength-selective filter at different angles. The optical waveguide routs the light that includes the plurality of the wavelengths.

In accordance with yet a further feature of the invention, there is provided, at least one reflecting surface. The optical waveguide is routed to and fro between the wavelength-selective filter and the at least one reflecting surface.

In accordance with an added feature of the invention, the optical waveguide is formed in an optically integrated manner in asubstrate.

In accordance with an additional feature of the invention, the substrate is an integrated optical chip.

In accordance with another feature of the invention, the substrate has a metallized surface that forms at least one reflecting surface; and the optical waveguide is routed to and fro between the wavelength-selective filter and the at least one reflecting surface.

In accordance with a further feature of the invention, the optical waveguide runs in a curved manner in the substrate such that the optical waveguide is repeatedly led up to the wavelength-selective filter at the different angles.

In accordance with a further added feature of the invention, at least one layer runs at an angle with respect to the wavelength-selective filter. The optical waveguide runs to and fro in a zigzag manner in the substrate such that the optical waveguide is repeatedly led up to the wavelength-selective filter at the different angles. Light is routed in the optical waveguide and is repeatedly reflected at the at least one layer.

In accordance with a further additional feature of the invention, the layer that runs at an angle with respect to the wavelength-selective filter is formed on the surface of the substrate.

In accordance with yet an added feature of the invention, light that includes the plurality of the wavelengths is coupled into the optical waveguide directly from the edge of the substrate.

In accordance with yet an additional feature of the invention, there is provided, a plurality of optoelectronic converters that are directly coupled to the substrate without using additional optics. Each one of the plurality of the optoelectronic converters detects coupled-out light of a respective separated one of the plurality of the wavelenghths.

In accordance with yet another feature of the invention, there is provided, a separate carrier element, and the wavelength-selective filter is formed on the separate carrier element.

With the foregoing and other objects in view there is also provided, in accordance with the invention, a method for operating on a plurality of wavelengths having optical signals. The method includes performing an operation that either multiplexes the plurality of the wavelengths having the optical signals by combining the optical signals in a wavelength-selective manner, or demultiplexes the plurality of the wavelengths having the optical signals by separating the optical signals in a wavelength-selective manner. The operation is performed by repeatedly deflecting the optical signals at respectively different angles onto a wavelength-selective filter such that at each one of the angles, only the optical signals of one specific wavelength are either coupled-in or coupled-out.

In accordance with an added mode of the invention, the light of the plurality of wavelengths is reflected to and fro between the wavelength-selective filter and at least one reflecting surface such that after each reflection, the light strikes the wavelength-selective filter at a different angle.

The invention enables the individual wavelengths of the optical signals to be combined or separated using only one wavelength-selective filter. The optical signals are routed in such a way that they repeatedly strike the wavelength-selective filter at respectively different angles. The optical signals of only one specific wavelength is coupled in or out for each angle.

The invention is therefore, based on the idea of performing the separation of the wavelengths not by using a plurality of different filters, but using a single filter that is illuminated or trans-illuminated at different angles. In this case, the wavelength-selective filter has a different filter characteristic for each irradiation angle: a specific angle corresponds to a specific wavelength that is separated by the wavelength-selective filter so that the wavelength ranges of the individual optical channels can be defined by the selection of the angles.

The invention has the great advantage that only one filter is needed for all of the optical channels or wavelengths. This is associated with a considerable savings in cost.

In a preferred refinement of the invention, the light of the plurality of wavelengths is reflected to and fro between the wavelength-selective filter and at least one reflecting surface of the device in such a way that, after each reflection, the light beams strike the filter at a different angle. A specific wavelength is coupled out for each angle.

At the same time, provision can be made both for only one wavelength to be let through by the wavelength-selective filter and for only one specific wavelength to be reflected by the wavelength-selective filter.

It is pointed out that, in precise terms, it is not just one specific wavelength that is coupled out for a specific angle, but a narrow-band wavelength range with a bandwidth of, for example, 5 to 10 nm.

In an advantageous development of the invention, a plurality of reflecting surfaces, which are arranged at an angle with respect to the filter, are provided in the device. Here, dependent on the desired angle at which the light is intended to strike the wavelength-selective filter, the individual surfaces can be inclined at the same or at a different angle with respect to the wavelength-selective filter. The reflecting surfaces can also be located, in each case, at a different distance from the wavelength-selective filter. This permits the distance between the points of incidence of the light on the filter to be set in a desired manner, in particular equidistantly.

In a preferred exemplary embodiment of the invention, the light of a plurality of wavelengths that are routed in an optical waveguide emerges from the optical waveguide. This light streams freely through an optical imaging system, in particular a lens, and is formed into a substantially parallel bundle of light that streams through the filter repeatedly, in each case at a different angle. The light beams of a specific wavelength are coupled out and are imaged, via a further optical imaging system, onto an optoelectronic converter, in particular a detector. The optical imaging systems are preferably integrated into a multichannel interface element, which constitutes a unit that is compact and simple to handle.

In this embodiment, the wavelength-selective filter is, for example, imaged on the surface of a monolithic multiplexing element. The reflecting surfaces are formed on an opposite surface of the multiplexing element, running at an angle to the filter. This provides a compact arrangement.

Alternatively, the wavelength-selective filter is not arranged directly on the surface of a multiplexing element, but on a separate carrier element, for example a glass substrate, which is then connected to the multiplexing element. This has the advantage that the wavelength-selective filter can be produced separately and pre-tested.

In an alternate refinement of the invention, the light of a plurality of wavelengths is routed in an optical waveguide, which is led repeatedly up to the wavelength-selective filter at different angles. In this case, the light is reflected in a wavelength-selective manner at the wavelength-selective filter, and is routed onward in the optical waveguide. By an appropriately curved routing of the optical waveguide and/or a reflection at a reflecting surface, the light in the optical waveguide is again led up to the wavelength-selective filter, this time at a different angle.

In this case, the optical waveguide is preferably formed in an optically integrated manner in a substrate, in particular an optically integrated chip. One or more reflecting surfaces can preferably be provided by a mirrored surface of the substrate. The optical waveguide can run in a curved manner or in a zigzag in the substrate. The light is preferably coupled into the optical waveguide directly at the substrate edge, without using additional optics. Likewise, the light separated into individual wavelengths is preferably selected using optoelectronic converters, which are coupled to the substrate directly and without using additional optics. However, it is also possible to arrange the optoelectronic converters in a carrier, which is then mounted at the edge of the substrate. A separate interface element can also be provided to couple light in.

Other features which are considered as characteristic for the invention are set forth in the appended claims.

Although the invention is illustrated and described herein as embodied in Device and Method for multiplexing and/or demultiplexing Optical Signals of a Plurality of Wavelengths, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows a first exemplary embodiment of a device for multiplexing and/or demultiplexing optical signals, the signals streaming repeatedly through an interference filter in a parallel bundle of light;

FIG. 2 shows a second exemplary embodiment of a device for multiplexing and/or demultiplexing optical signals, the light being routed in an optical waveguide running in a curved manner;

FIG. 3 shows a third exemplary embodiment of a device for multiplexing and/or demultiplexing optical signals, the light being routed in an optical waveguide that runs in a zig-zag manner; and

FIG. 4 shows angle dependent transmission characteristics.

### DESCRIPTION OF THE PREFERRED EMBODIMENTS

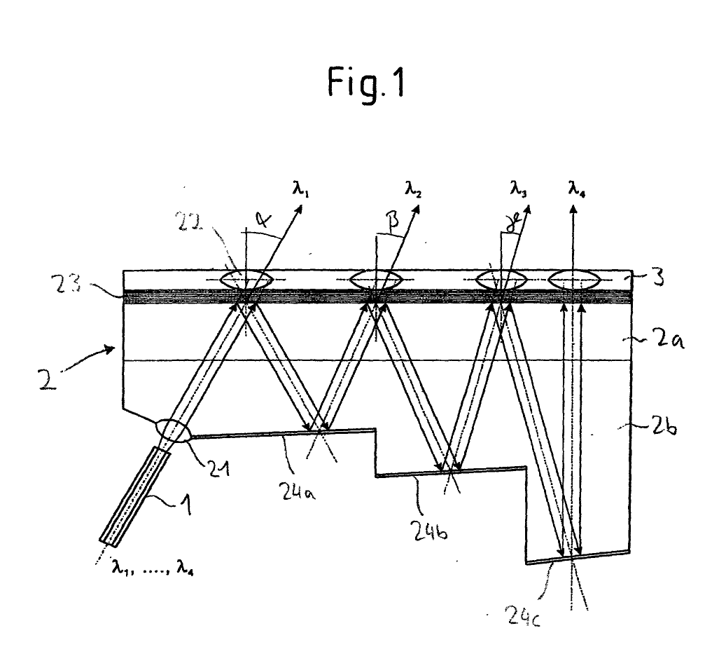

Referring now to the figures of the drawing in detail and first, particularly, to FIG. 1 thereof, there is shown a glass fiber 1 that routes the light of a multiplicity of wavelengths λ1, . . . λ4. Each wavelength provides an optical data channel for the transmission of data. The individual wavelengths λ1, . . . λ4 are separated using a demultiplexer 2 so that they can be detected separately. Given converse beam routing, the demultiplexer 2 can also be used as a multiplexer.

The demultiplexer 2 has a first optical imaging system 21, a plurality of second optical imaging systems 22, an interference filter 23, and a plurality of reflecting surfaces 24a, 24b, 24c running at an angle with respect to the interference filter 23.

The first optical imaging system 21 which, in the exemplary embodiment illustrated is a convex lens 21, forms the light beams of the plurality of wavelengths emerging from the glass fiber 1 into a virtually parallel bundle of light that falls on the interference filter 23 at a first angle a. The interference filter 23 includes a multiplicity of layers of different refractive index that are each λ/4 and λ/2 thick. For example, the layers alternately consist of SO₂ and TiO₂, or of ZrO₂ and MgF₂. Such interference filters are known per se.

The parallel light bundle falls on the interference filter 23 at an angle α, at which precisely one wavelength λ1 is let through by the interference filter, while the other wavelengths λ2, λ3, λ4 are reflected. In the process, the light of wavelength λ1 passes through the interference filter 23 substantially without deflection.

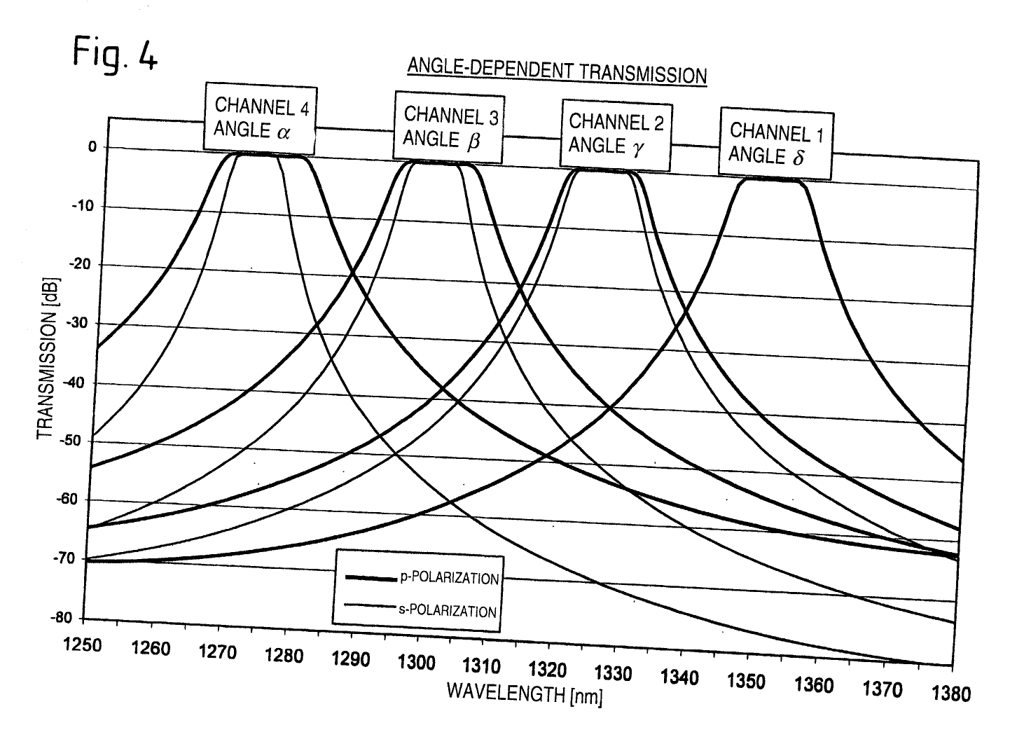

The angle α at which the wavelength λ1 is coupled out in this case depends on the interference filter used, on the wavelength coupled out, and on the desired bandwidth of the filter at the wavelength considered. In this case, the highest wavelength that can be separated by the filter is coupled out at the smallest angle of incidence (0° ), and smaller wavelengths are coupled out at an increasingly greater angle (Also see FIG. 4).

The light of the wavelength λ1 that is let through by the interference filter 23 can be imaged onto a detector (not illustrated) by the second optical imaging system 22, which may be a lens, or can alternatively be coupled into an optical waveguide. In this case, as distinct from the illustration in FIG. 1, the lens 22 can be made to deflect the transmitted light in a suitable way, and in so doing, image it onto a detector or couple it into an optical waveguide.

The light of the wavelengths λ2, λ3, λ4 that is reflected by the interference filter 23 is reflected again at a reflecting surface 24a of the multiplexer 2. The reflecting surface 24a is arranged at an angle to the interference filter 23. This leads to the light that is reflected at the reflecting surface 24a then falling on the interference filter 23 at a different angle β. For the different angle of incidence β, the interference filter 23 has a different wavelength selectivity, so that now the wavelength λ2 is coupled out and imaged onto a detector (not illustrated) via a lens 22.

The reflected light of the wavelengths λ3, λ4 is in turn reflected at an obliquely arranged reflecting surface 24b, and is routed to the interference filter 23 at a third angle γ. Here, the wavelength λ3 is then coupled out. The remaining wavelength λ4 is reflected at a reflecting surface 24c of the multiplexer 2, again arranged at an angle, and then falls perpendicularly onto the interference filter 23, which at this angle, is transparent to the wavelength λ4 that still remains.

Of course, the same principle can also be used for separating a different number of wavelengths. In the manner described, by using only one filter, the wavelengths λ1, . . . , λ4 are separated. Each wavelength that is separated strikes the interference filter 23 at a different angle.

The demultiplexer 2 preferably consists of a monolithic multiplexing element having one surface with the interference filter 23 formed thereon and having an opposite surface with the reflecting surfaces 24a, 24b, 24c arranged at angles and formed as steps.

The second optical imaging systems or lenses 22 are preferably integrated into an interface element 3 that is placed onto the interference filter 23.

For more simply producing the multiplexing element, it may also include two subareas 2a, 2b. The interference filter 23 can then be fitted to one subarea 2a and the obliquely arranged reflecting surfaces 24a, 24b, 24c and the first optical imaging system 21 can be formed on the other subarea 2b. The subarea 2a with the interference filter in this case provides a separate carrier element for the interference filter. The two sub-elements 2a, 2b are placed directly one on the other along a parallel interface.

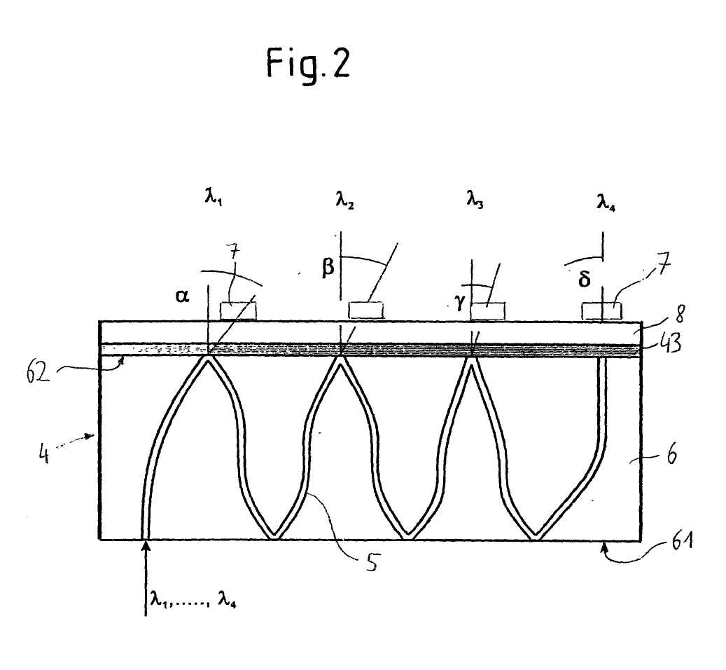

FIG. 2 shows a plan view of an alternate exemplary embodiment of a demultiplexer 4, in which the light of a plurality of wavelengths λl, λ2, λ3, λ4 is routed in an optical waveguide 5. In this case, the optical waveguide 5 is formed in an optically integrated manner in a substrate 6. An interference filter 43 is arranged at the upper edge 62 of the substrate 6 (at right angles to the plane of the drawing). The interference filter 43 is formed on a carrier 8 that is fixed to the substrate 6. The lower substrate edge 61 is metallized, so that it acts as a mirror. Alternatively, the interference filter 43 can also be formed at the substrate edge 61 without using a carrier 8.

Light of the various wavelengths λ1, . . . , λ4 is coupled directly into the optical waveguide 5 at the substrate edge. In the optical waveguide 5, the light is routed to the wavelength-selective filter 43 at a first angle α. As explained with reference to FIG. 1, a wavelength λ1 is coupled out, while the further wavelengths are reflected. In the optical waveguide 5, these reflected further wavelengths are routed away from the filter 43 at an angle toward the lower, silvered substrate edge 61, are then reflected there, and are then routed onto the interference filter 43 at a second angle β by the curved optical waveguide 5. The wavelength λ2 is then coupled out. Following further reflections at the metallized substrate edge 61, the light is deflected into the optical waveguide 5 at an angle γ and finally deflected onto the interference filter 43 perpendicularly such that the wavelengths λ3, λ4 that still remain are coupled out.

The respective wavelengths that are coupled out are in turn detected by an optoelectronic converter, in particular a photodiode 7, which is illustrated only schematically. The photodiodes 7 are coupled onto the integrated optical chip 6 or the carrier 8 directly, and without using additional optics. Alternatively, a carrier element is provided for the photodiodes 7, and the carrier is connected to the carrier 8.

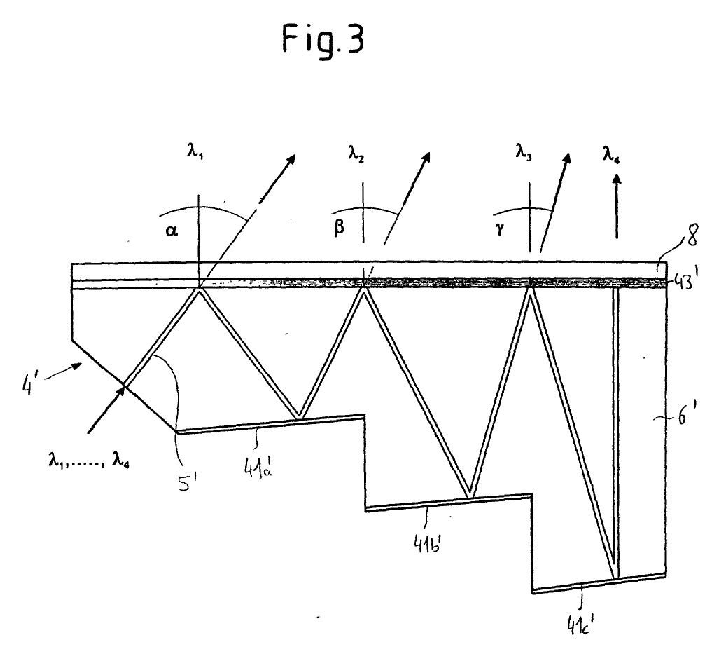

The exemplary embodiment of FIG. 3, just like FIG. 2, relates to a four-channel demultiplexer, in which the light is routed in an optical waveguide 5′. Differing from that in FIG. 2, the waveguide 5′ in this case runs in a zig-zag, and in straight lines on the respective subsections in the substrate 6′. The functional mechanism when coupling the wavelengths λl, λ2, λ3, and λ4 out is the same as that described with reference to FIGS. 1 and 2. Because of the zig-zag routing of the optical waveguide 5′ in the substrate 6′, however, it is not just one metallized reflecting surface that is provided, as in FIG. 2, but a plurality of metallized reflecting surfaces 41a′, 41b′, 41c′ that are each arranged at an angle, that is to say not parallel, to the interference filter 43′. For this purpose, the substrate 6′ is provided with edges running appropriately at an angle, at which the reflecting surfaces 41a′, 41b′, 41c′ are implemented.

Optoelectronic converters for detecting the separated wavelengths are again coupled to the substrate or the integrated optical chip directly and without using additional optics, or alternatively, are provided in a carrier element for the converters. Likewise, the light can, in each case, be coupled into an optical waveguide, where each optical waveguide transmits a separated wavelength.

It is pointed out that, in FIG. 3, as in FIG. 1, the edges running obliquely and having the reflecting surfaces 41a′, 41b′, 41c′ are, in each case, arranged at a different distance from the interference filter 43′. This permits the distance between the points of incidence of the light on the interference filter to be set to a desired value, in particular equidistantly. Thus, in FIGS. 1 and 3, the distance between the first three points of incidence, and correspondingly also, the distance between the associated optical imaging systems 22 and converters is equidistant. If, in FIGS. 1 and 3, the edge having the reflecting surface 24c, 41c′ would have a greater distance from the interference filter 23, 43′, the last point of incidence would also be equidistant.

Here, consideration must be given to the fact that the necessary angle of incidence is defined by the wavelength to be separated. Nevertheless, an equidistant arrangement of the imaging systems and converters can be provided by using a suitable setting of the distance between the individual edges or reflecting surfaces, which has the advantage of simpler provision of these systems and components in a carrier element.

FIG. 4 shows the angle-dependent transmission of a wavelength-selective filter. The transmission is shown both for p-polarization and for s-polarization of the light. It is easy to see that, for different angles at which the light falls on an interference filter, the interference filter is transmissive for different wavelengths. Given knowledge of the angle-dependent transmission, the light of the wavelength to be separated is directed onto the interference filter at the respectively requisite angle.

It is pointed out that the angular dependence of the transmission of an interference filter is an inherent characteristic of an interference filter, and it requires no further measures to provide such an angular dependence.

In terms of its embodiment, the invention is not restricted to the exemplary embodiments illustrated above. For example, it is likewise possible for the interference filter to be designed such that only one specific wavelength is reflected and the other wavelengths are transmitted. If the transmitted wavelengths are reflected and routed back to the interference filter at a different angle, the result in this case is a function that is the same as that shown in FIGS. 1-3.

The essential factor for the invention is merely that the optical signals are routed in the multiplexer/demultiplexer in such a way that they strike a wavelength-selective filter repeatedly at different angles, where a specific wavelength is coupled out for each angle.

We claim:

1. An optical device, comprising:
only one wavelength-selective filter for performing an operation selected from the group consisting of combining a plurality of wavelengths having optical signals in a wavelength-selective manner and separating a plurality of wavelengths having optical signals in a wavelength-selective manner;
said optical signals being routed to repeatedly strike said wavelength-selective filter at respectively different angles such that at each one of said angles, only said optical signals of a specific one of said plurality of said wavelengths are acted upon in a manner selected from the group consisting of being coupled in and being coupled out.

2. The device according to claim 1, comprising:
at least one reflecting surface;
light including said plurality of said wavelengths being reflected to and fro between said wavelength-selective filter and said at least one reflecting surface such that after each reflection from said at least one reflecting surface, said
light strikes said wavelength-selective filter at a different one of said angles.

3. The device according to claim 2, comprising:
a plurality of reflecting surfaces that are configured at an angle with respect to said wavelength-selective filter;
said plurality of said reflecting surfaces including said at least one reflecting surface.

4. The device according to claim 3, wherein: each one of said plurality of said reflecting surfaces are inclined at a different angle with respect to said wavelength-selective filter.

5. The device according to claim 4, wherein: each one of said plurality of said reflecting surfaces are at a different distance away from said wavelength-selective filter.

6. The device according to claim 3, wherein: each one of said plurality of said reflecting surfaces are at a different distance away from said wavelength-selective filter.

7. The device according to claim 1, in combination with an optical waveguide emitting light including said plurality of said wavelengths, the device comprising:
an optical imaging system forming said light into a substantially parallel bundle of light including said plurality of said wavelengths;
each one of said plurality of said wavelengths of said substantially parallel bundle streaming through said wavelength-selective filter at an angle that is different from other ones of said plurality of said wavelengths of said substantially parallel bundle.

8. The device according to claim 7, comprising:
a plurality of detectors; and
a plurality of further optical imaging systems for imaging each one of said plurality of said wavelengths of said substantially parallel bundle onto a respective one of said plurality of said detectors.

9. The device according to claim 8, comprising:
a multichannel interface element;
said plurality of said further optical imaging systems being integrated into said multichannel interface element.

10. The device according to at claim 7, comprising:
a multiplexing element having a surface on which said wavelength-selective filter is configured;
said multiplexing element having at least one further surface forming a plurality of reflecting surfaces that are configured obliquely.

11. The device according to claim 1, comprising:
an optical waveguide being repeatedly led up to said wavelength-selective filter at different angles;
said optical waveguide routing light including said plurality of said wavelengths.

12. The device according to claim 11, comprising:
at least one reflecting surface;
said optical waveguide being routed to and fro between said wavelength-selective filter and said at least one reflecting surface.

13. The device according to claim 11, comprising:
a substrate;
said optical waveguide being formed in an optically integrated manner in said substrate.

14. The device according to claim 13, wherein: said substrate is an integrated optical chip.

15. The device according to claim 13, wherein:
said substrate has a metallized surface forming at least one reflecting surface; and
said optical waveguide is routed to and fro between said wavelength-selective filter and said at least one reflecting surface.

16. The device according to claim 13, wherein: said optical waveguide runs in a curved manner in said substrate such that
said optical waveguide is repeatedly led up to said wavelength-selective filter at said different angles.

17. The device according to claim 13, comprising:
at least one layer running at an angle with respect to said wavelength-selective filter;
said optical waveguide running to and fro in a zigzag manner in said substrate such that said optical waveguide is repeatedly led up to said wavelength-selective filter at said different angles; and
light being routed in said optical waveguide and being repeatedly reflected at said at least one layer.

18. The device according to claim 17, wherein:
said substrate has a surface; and
said at least one layer that runs at an angle with respect to said wavelength-selective filter is formed on said surface of said substrate.

19. The device according to claim 13, wherein:
said substrate has an edge; and
light including said plurality of said wavelengths being coupled into said optical waveguide directly from said edge of said substrate.

20. The device according to claim 13, comprising:
a plurality of optoelectronic converters that are directly coupled to said substrate without additional optics;
each one of said plurality of said optoelectronic converters detecting coupled-out light of a respective separated one of said plurality of said wavelenghths.

21. The device according to claim 1, comprising:
a separate carrier element;
said wavelength-selective filter being formed on said separate carrier element.

22. A method for operating on a plurality of wavelengths having optical signals, which comprises:
performing an operation selected from the group consisting of multiplexing the plurality of the wavelengths having the optical signals by combining the optical signals in a wavelength-selective manner, and demultiplexing the plurality of the wavelengths having the optical signals by separating the optical signals in a wavelength-selective manner; and
performing the operation by repeatedly deflecting the optical signals at respectively different angles onto a wavelength-selective filter such that at each one of the angles, only the optical signals of one specific wavelength are acted upon in a manner selected from the group consisting of being coupled-in and being coupled-out.

23. The method according to claim 22, which comprises: reflecting light of the plurality of wavelengths to and fro between the wavelength-selective filter and at least one reflecting surface such that after each reflection, the light strikes the wavelength-selective filter at a different angle.
